(19) United States
(12) Patent Application Publication
(10) Pub. No.: US 2024/0205726 A1
(43) Pub. Date: Jun. 20, 2024

(54) METHODS AND SYSTEMS FOR EXTENDING THE NETWORK EDGE

(71) Applicant: Matrixspace Corporation, Burlington, MA (US)

(72) Inventor: Matthew T. Kling, Uxbridge, MA (US)

(21) Appl. No.: 18/545,725

(22) Filed: Dec. 19, 2023

Related U.S. Application Data
(60) Provisional application No. 63/433,612, filed on Dec. 19, 2022.

(51) Int. Cl. H04W 28/02

(52) U.S. Cl. CPC H04W 28/0236; H04W 84/18

(57) ABSTRACT

Systems and methods are provided for extending the network edge. An edge gateway may be deployed in a mesh network that includes one or more drones, with the edge gateway including a radio configured for communication within the mesh network, one or more circuits configured for one or both of controlling and processing of data, a communication module that includes one or more circuits configured for facilitating communication with one or more remote systems and one or more local devices that are not part of the mesh network.

### CLAIM OF PRIORITY

This patent application makes reference to, claims priority to, and claims benefit from U.S. Provisional Patent Application Ser. No. 63/433,612, filed on Dec. 19, 2022. The above identified application is incorporated herein by reference in its entirety.

### TECHNICAL FIELD

Aspects of the present disclosure relate to communication solutions. More specifically, various implementations of the present disclosure relate to methods and systems for extending the network edge.

### BACKGROUND

Operation of an RF communication network in a dynamic, and sometimes hostile, RF environment poses many challenges, especially if the nodes in the network are highly mobile and the RF environment is rapidly changing. Each node is subject to interference, and the longer the distance to be covered, the more susceptible nodes are to interfering signals while power and antenna requirements increase.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for extending the network edge, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 shows an aerial drone that may be utilized in accordance with an example embodiment of the disclosure.

FIG. 2 shows a drone swarm that has formed a mesh network.

FIG. 3 shows a network arrangement comprising an example edge gateway, in accordance with an example embodiment of the disclosure.

FIG. 4 shows an example use case of an edge gateway, in accordance with an example embodiment of the disclosure.

FIG. 5 shows an example network architecture with edge gateway in communication with network nodes, local resources and remote resources, in accordance with an example embodiment of the disclosure.

FIG. 6 shows an example implementation of a drone that may be utilized in accordance with an example embodiment of the disclosure.

FIG. 7 shows a flowchart of an example method of utilizing edge gateways, in accordance with an example embodiment of the disclosure.

FIG. 8 shows an example network architecture that comprises a drone internal network, an edge network, and a cloud network, in accordance with an example embodiment of the disclosure.

FIG. 9 shows an example use case in a network architecture that comprises a drone network, a cloud network, and a cellular network, in accordance with an example embodiment of the disclosure.

FIG. 10 shows another example use case in a network architecture that comprises a drone network, a cloud network, and a cellular network, in accordance with an example embodiment of the disclosure.

### DETAILED DESCRIPTION

Communications networks involve tradeoffs in range, bandwidth, power, and noise immunity. A mesh network is a form of network where the distance covered can be extended by hopping communications through intermediate nodes. Instead of hopping along a single path, a mesh topology allows a communication link to be set up on any of multiple paths through the mesh. A mesh routing protocol allows a link to be set up between any two nodes over any available path through the mesh. If a link is broken because of interference or loss of a node, the protocol establishes a new route through the mesh. Accordingly, a mesh network is resilient and self-healing.

Existing mesh network implementations use nodes that are largely static or operate with omnidirectional antennas and operate at relatively lower frequencies. The present disclosure contemplates a mesh network of fixed or highly mobile nodes, with a preferred embodiment that operates as a swarm of aerial nodes, where the mesh may choose paths that reject interference based on directional properties of the node antennas and their transmission and reception. In addition, the network is implemented with millimeter (mm) wave radios. Millimeter wave is high frequency, high-bandwidth, and thus offers higher data rates, than Wi-Fi bands. The mm wave spectrum is also less crowded with competing applications, especially above the highest frequency cellular bands. Another advantage of mm wave is that antenna size decreases with increasing frequency, allowing for more sophisticated, higher gain antennas in smaller, lighter weight packages. Phased array antennas allow for increased gain, and in particular, by adjusting the phase and amplitude of each element in the array, the antenna gain can be adjusted and steered so that the antenna is highly directional and rapidly adjustable, an important feature for the highly dynamic nature of the disclosed mesh network.

In a mesh network of nodes with omnidirectional antennas, an interfering RF emitter will continue to interfere with nearby nodes no matter how the node is oriented relative to the interferer. Even if the node is mobile, changing the orientation of the node or minor adjustments in location are unlikely to alleviate the interference. However, by using a mesh network with directional antennas, such as phased array antennas, for example, nodes that are being interfered with may steer their antennas' beam patterns towards a node that is in a direction with less interference, use or select a different route through the mesh network that uses nodes whose antenna orientation is not aligned with the source of interference, and/or adjust the beam pattern so that a notch or null in the beam pattern is aimed at the interferer while only losing a slight amount of gain relative to peak gain. Nearby nodes that are within range of the interferer may also make these adjustments to their beam pattern as well. This may be done at high speed, with physically moving the node in space maintained as another option.

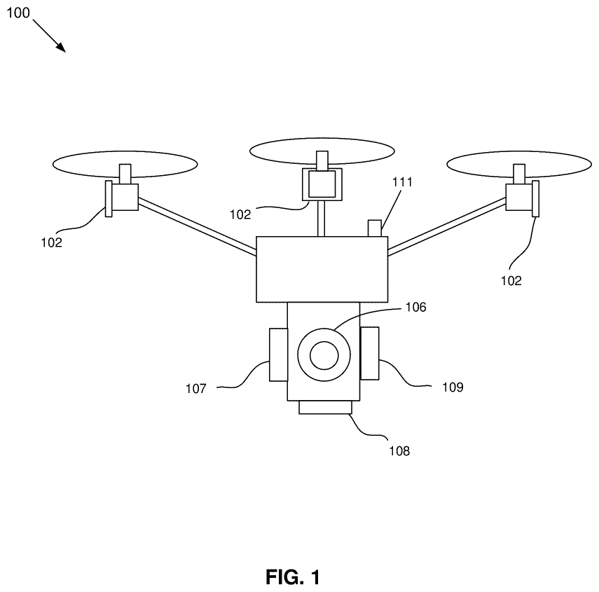

FIG. 1 shows an aerial drone that may be utilized in an accordance with an example embodiment of the disclosure. The drone 100 is not crewed and is preferably lightweight with a useful payload (e.g., up to 10 pounds). The drone is equipped with directional, planar phased array antennas 102. While FIG. 1 only has three motor/blade mechanisms visible, there is a fourth directly behind the front one, although a higher number may be utilized, such as six, eight, or twelve for example. The arrays 102 can be mounted on any convenient surface on the drone to achieve the desired coverage based on the capability of the array, as further explained herein.

The drone is also equipped with sensors for collecting information. In the embodiment shown, the sensors include an optical imager 106, an infrared sensor 107, a LIDAR imager 108, an acoustic sensor 109, radar, and software-defined radio (SDR) for RF spectral sensing. The drone may comprise additional hardware for guidance, including a satellite position system antenna 111 and an inertial “dead reckoning” accelerometer and magnetic compass (not shown). Nonetheless, in some implementations, other means of navigation may be used, such as visual sensing, Radar sensing, or Lidar sensing. The phased array antennas may be of any size, with an element size designed for the millimeter wave range, generally in the range of 10 to 200 GHz. While any operating frequency could be chosen, the preferred embodiment operates at 24 GHz. In this mode of operation, line of sight communication of the radio links described herein is reasonable out to a single digit mile radius, with link distances typically under one mile.

Altitude is an important parameter for locating the drone in space, and essential for avoiding terrain. The drone preferably employs a combination of techniques for determining and maintaining altitude. Laser range finding, such as LIDAR, provides fast and accurate altitude information provided visibility is good. An on-board pressure altimeter provides a secondary reference, and the phased array antennas 102 may be used to provide ranging information to points on the ground using trigonometry if the ground surface is sufficiently reflective. Satellite provided GPS may also provide an estimate of altitude above the surface of the earth. Combining all these sources and comparing them to an on board reference map of the area of operation provides an accurate assessment of current altitude and contributes to a refined assessment of the drone's absolute position in space, further described below.

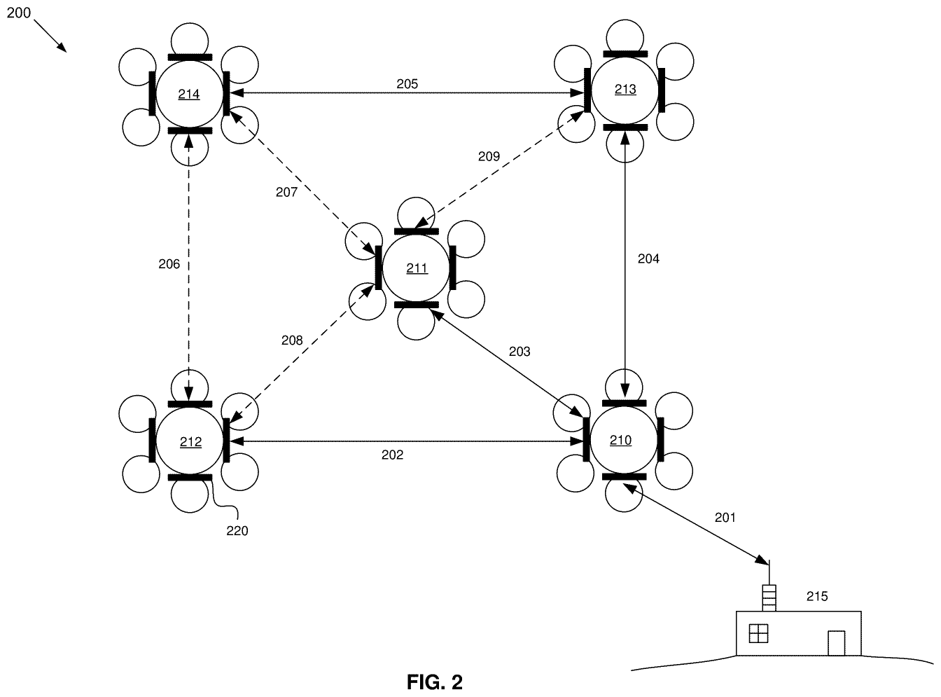

FIG. 2 shows a network 200 of aerial drones 210-214 forming a mesh network of links 201-209. Each of the drones 210-214 may comprise one or more phased array antennas 220, where the number of antenna arrays may ensure full 360° coverage. The network has a root at a ground or base station 215, which is shown as a static location but could also itself, be mobile. Dashed line links 206-209 represent alternate links between drones that are not active. Each drone acts as node in the network. It is not required that all nodes operate at the same frequency, and to avoid interference between nodes that are lined up such that a third further node is in the peak energy beam of a radio link between a first and second node, the network may employ several alternate neighboring frequencies.

Illustrated in FIG. 2 for illustrative purposes is a drone swarm of unmanned aerial vehicles or drones. Each drone in the swarm is also a communications node and is equipped with one or more phased array, electrically steerable antennas and a transceiver operating in the millimeter wave region. Each drone may also be equipped with one or more sensors, such as optical, LIDAR, thermal, or acoustic sensors. The drones carry an on-board processor and memory for controlling the drone's movements, operating the sensors, and managing the transceiver. The drones also carry antennas and a processor for determining position based on satellite data (e.g., Global Positioning System (GPS) or the like) and optionally an on-board inertial and magnetic (compass) sensor. The drones communicate with each other to form a mesh network of communication nodes with an RF link back to a root node, base station, or other target node in the network. The nodes respond to interference from jammers and obstacles by finding new paths through the mesh, steering the millimeter wave beam, re-positioning, or a combination of these techniques.

Path loss of a radio link increases proportional to the square of frequency. For example, going from 2.4 GHz which is roughly a common frequency for cell phones and 2.4 GHz Wi-Fi to 24 GHz would result in a path loss that is 100 times higher, or 20 dB. Going from 2.4 GHz to 80 GHz would have a 30 dB increase in path loss. In a free space propagation condition, the path loss increases by 20 dB for every decade of distance. Therefore, going from 2.4 GHz to 24 GHz would reduce the link distance by a factor of 10, and the link distance for an 80 GHz link would decrease by a factor of 33. However, high frequencies have the benefit of very wide bandwidths and thus faster data rates. Additionally, the size of the antenna decreases with frequency (wavelength), enabling the use of more complex, higher gain antennae to combat the increase in path loss. Higher gain results from focusing the energy, thereby resulting in highly directional antennas.

The phased array antenna consists of numerous antenna that have their amplitude and phase adjusted to steer the beam by adjusting summation and cancellation of signals from various directions. The focusing of the energy, often in both azimuth and elevation, creates a higher gain antenna. However, the very focused beam is preferably pointed in the right direction to facilitate communication. Additionally, the focusing of the beam means the transmission/reception in directions away from the main beam is attenuated, which may enable the avoidance of interference.

Furthermore, the phased antenna arrays may help with isolation of communication channels such as transmitting in one direction and receiving in another. Phased array antennae utilize software to control the gain/phase of each antenna element for steering of the beam, where the system is aware of which direction to steer the beam. The beams may be steered by knowledge of relative GPS locations or drone formation which may be known based on a flight plan or shared over a communications link. The beams may also be steered by scanning the beam and/or with closed-loop tracking. One typical implementation of a phased array antenna uses a planar array of patch antenna elements. This has the advantage of being flat and thus can fit well onto an aircraft without significant size and aerodynamic implications.

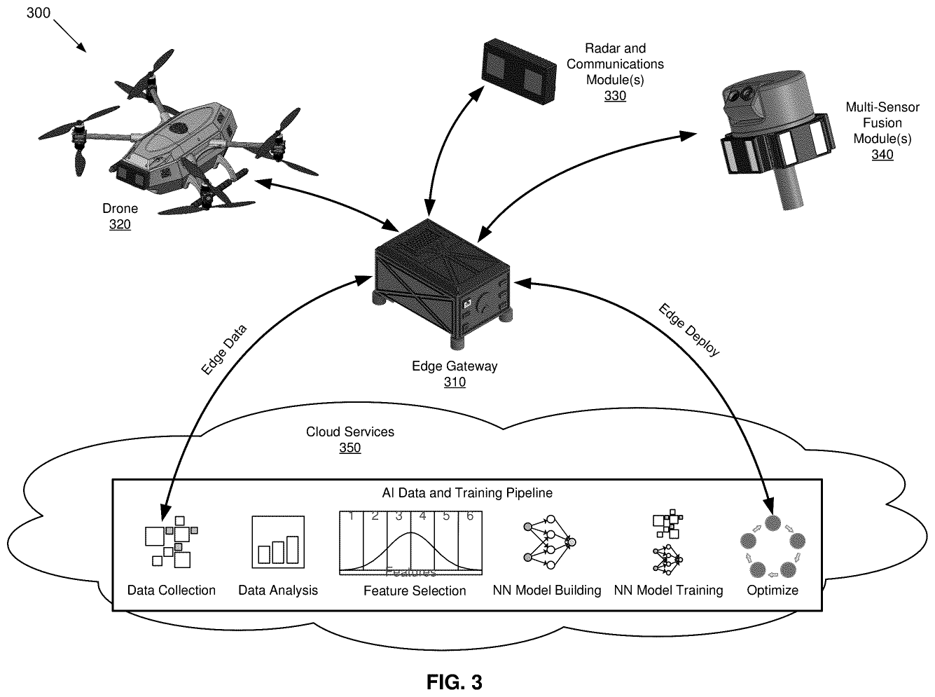

FIG. 3 shows a network arrangement comprising an example edge gateway, in accordance with an example embodiment of the disclosure. Shown in FIG. 3 is a network arrangement 300. The network arrangement 300 comprises, for example, one or more edge gateways 310, which may be in communication with one or more aerial drone(s) 320 (as described herein), one or more radar and communication elements 330, one or more multi-sensor(s) 340 and a cloud 350.

Network arrangements such as the network arrangement 300 may be configured for extending the network edge—e.g., to extend network edge(s) beyond reach of coverage areas of current 4G/LTE, 5G, etc. In this regard, extending the network edge may comprise, e.g., providing high bandwidth and low latency mesh connectivity with cloud backhaul, enabling point-of-operations real time data (e.g. video, audio, data, etc.) streaming to local nodes without having to go through the cloud, streaming to cloud for near-real time data services, data storage, and offline analysis, and/or performing advanced edge computing, including, e.g., real-time artificial intelligence (AI) based data analytics. For example, as illustrated in FIG. 3, the AI based data analytics may take place in the cloud. However, the disclosure is not so limited, and as such AI based data analytics may be performed in other components, such as the edge gateway, which may be configured to serve as a local aggregator and processor of data. Network arrangements such as the network arrangement 300 may also be configured for additional services, such as, e.g., enabling enterprises-scale deployment of aerial vehicles, ground vehicles, fixed sensors, and more, interoperating with any existing networks using intelligent routing at the edge, and/or securing data from end-to-end using fully encrypted links (e.g., AES-256 encrypted links).

Extending the network edge may be achieved by incorporating within networks (or network arrangements) new devices (or network nodes) configured for facilitating and supporting extending the network edge related services or functions, and/or by modifying existing devices (or network nodes) to facilitate and/or support these services or functions. For example, in various implementations edge gateways (such as the edge gateways 310) may be used. Use of such edge gateways may be, in some instances, in combination with use of radios (e.g., radios) that may be optimized for supporting operation of these edge gateways. These radios may be used within the edge gateways as well as within other network nodes. Use of edge gateways (and extending the network edge as a whole) may be desirable especially in such settings, such as in remote area with poor coverages. Such edge gateways may be used provide local coverage to drone(s), as well as local users (e.g., via hotspot) and cloud access (e.g., to enable remote use/access). Local users may utilize such devices as mobile phones, laptops, tablets, TVs, etc. In this regard, local users may connect to the edge gateway via local connections (e.g., Wi-Fi links). The edge gateway provides link to the local radio (e.g., or any radio).

The edge gateway may be configured to enable real-time adjustment/throttling of data going to the cloud based on bandwidth available. In some instances, the edge gateway may provide data in adaptive manner to optimize performance—e.g., providing full data to local users, and reduced data rate to the cloud/remote users. The use of edge gateways may also allow for eliminating loop from drone to cloud and then back to the user. Such loop may include 4G/LTE, 5G, Wi-Fi, etc. Optimized radios may be used. Further, the radios may be swappable, such that different operators may swap radios based on, e.g., use conditions, preferences, etc. The radio may provide local high bandwidth mesh to enable the drone/devices to connect to the local edge gateway. Local radio/mesh may connect to drones, fixed sites (e.g., sensor(s) with radios), police cruiser, sensors, etc. As noted, extending the network edge may include and/or require cloud access. In this regard, cloud access may be done in secure manner, such as through virtual private network (VPN), which is typically unavailable in existing solutions—that is, existing drones and feeds provided thereby may not include or entail use of VPN.

In various implementations, the edge gateway may incorporate a local radio on one side (e.g., or other), network/cloud interface on the other side (e.g., local networks, 4G/LTE, 5G, etc.). This enables the edge gateway to provide local network for all local users (e.g., wired connectivity, such as via Ethernet, Universal Serial Bus (USB), etc., and/or wireless connectivity, such as via Wi-Fi, Bluetooth, etc.). The edge gateway may also be configured to support and utilized special communication protocols, such as for security reasons (e.g., as required by government agencies). The local network access provided by the edge gateway may be high bandwidth and low latency access. The edge gateway may be deployed in different ways—e.g., may be deployed as fixed setup or mobile setup (e.g., via a drone, vehicle, or any suitable deployable mobile platform).

In an example implementation, an edge gateway may be used in forming intelligent mesh to cloud network gateway. Such edge gateway may be characterized by low latency/high bandwidth local data access, parallel cloud data streaming for cloud data access, and on-board edge data aggregation and processing. Such edge gateway may provide multiple mesh endpoint connectivity, mesh to cloud routing (e.g., using Amazon Web Services (AWS) or the like), mesh to local device data stream access (e.g., using Wi-Fi or the like), low latency, and guaranteed connectivity. Mesh connectivity may be provided using phased array (e.g., 24 GHz phased array antenna system). Local device connectivity may be provided using, e.g., 802.xx (e.g., 802.11ac, 802.11ax, 802.11an, etc.) dual band, which may support large number (e.g., 10 or more) Wi-Fi users (e.g., at 433 Mbps), and/or via wired Ethernet for expanded users. Cloud connectivity may be provided via 4G/LTE Cat 12 connections (e.g., 600 Mbps DL, 150 Mbps UL), with FirstNet capability, and/or RJ45 Ethernet (e.g., at 1 Gbps). In terms of physical characteristics, the edge gateway may have small form factor (e.g., 8.5″×5.5″×3.5″). Such edge gateway (and services provided thereby) may be suitable for various applications, such as enterprise UAV operations, distributed sensor networks, security systems, sensor fusion applications, etc.

In another example implementation, an edge gateway may be used in providing gateway functions to provide a sensor mesh fully connected to cloud network. Such implementation may comprise use of an enterprise 4G/LTE or 5G radio embedded in router to provide Cloud backhaul, which may be characterized by having LTE CAT 12 with 600 Mbps DL and 150 Mbps UL, 2×2 multiple-input and multiple-output (MIMO) antenna for enhanced performance, and an option to hard-wire via standard 1 Gbps Ethernet (e.g., if 4G/LTE or 5G not available). The mesh data link may be used with a single edge gateway connecting to multiple sensor nodes. In some instances an intelligent cloud router may be used, with a single gateway providing cloud backhaul to multiple sensor nodes, with high performance embedded CPU and GPU for edge data processing. Such Intelligent cloud router may provide internet access where none exists, and may optionally provide Wi-Fi access point (AP) function. Communication with the cloud may be done via secure VPN connection, which may be encrypted with AES-256 and TLS, with real-time streaming/upload of local data to the cloud. Further, in some instances, a cloud compute platform may be used for customized application deployment. For example, in one implementation AWS Virtual Private Cloud (VPC) may be used for customized application deployment, with Customizable VPC cloud servers for customer specific apps.

An edge gateway implemented based on the present disclosure may simplify multi-device connectivity at the point of operations for drones, sensor networks, and security systems. The edge gateway integrates seamlessly with mesh networks and can be customized to interoperate with other point-to-point or point-to-multipoint radio networks. When paired with enabled drones or sensors, the edge gateway provides a full end-to-end network solution enabling local Wi-Fi device to mesh connections as well as remote internet-enabled device connectivity. It provides low latency, high bandwidth local communications from the radio/mesh network to a local Wi-Fi network, and then backhauls all data to the Cloud over 4G/LTE, 5G or wired Ethernet.

As noted, in various example implementations, optimized radios such as radios may be used—e.g., being deployed within the edge gateway(s), the drone(s), and other component(s) of the networks (e.g., sensors). An example 24 GHz Mesh Radio may be used in supporting Edge Connectivity Solutions. Such radio may incorporate software-defined, beam steerable mmWave phased array module, with integrated baseband processing, transceiver, RF-front end and antennas, and with single and dual array versions being available. The radio may be configured to support long-range high-speed mesh communications with interference reduction. Such communications may allow for data rates similar to Wi-Fi communication but at ranges that are better than (e.g., 5×-50×) Wi-Fi communication, while also being mesh capable for increased reliability/redundancy and range extension, and also allowing for combination of mesh operation and focused energy provides enhanced interference rejection and network security. The radio may have simple interface—e.g., appearing as a Wi-Fi device through USB 3.0 Interface. To optimize performance, the radio may have very small form factor (e.g., 5″×3.5″×1.25″) and/or may be light weight (e.g., 500 g or less). As for communication performance, the radio may support high-speed long-range data (e.g., >200 Mbps up to 1 km), may have large field of view (e.g., 120° in azimuth and elevation). The radio may support use of secure data link(s) (e.g., with AES-256 encryption). The radio may be adaptively deployable—e.g., UAVs, EVTOL, robots, in deployable portable systems, security systems, etc.

In various implementations, the edge gateway connects to one or more radio network endpoints, and then routes that data securely by acting as a local Wi-Fi access point as well as a secure VPN gateway/router to the cloud. Using a secure cloud communication (e.g., using AWS Virtual Private Cloud), any authorized device in the world is able to access live mission/operation data as well as data stored in the cloud, such as using suitable cloud software solutions. Local devices at the point of operations are provided with persistent and assured communications that do not suffer from severe bandwidth or latency bottlenecks experienced by those connected through the cloud, which is critical for security, inspection, overwatch, or other missions that rely on timely delivery of high bandwidth sensor data.

In some implementations, the drones (e.g., the aerial drone(s) 320 in FIG. 3) may also be configured to optimize extending the network edge related services and functions. For example, drones may be configured to support beyond visual line of sight (BVLOS) operations, may incorporate radars providing full (360°) field of view coverage, and may support Automatic Dependent Surveillance-Broadcast (ADS-B), camera feed, and possibly thermal imaging. In this regard, use of capable but low size, weight, power and cost (SWaP-C) radar(s) that provide at least 90° but preferably full (360°) field of view coverage is very desirable. In particular, where full (360°) field of view coverage may not be possible, a radar with 90° field of view may be used to acquire full (360°) field of view coverage—e.g., with the drone being spun around in a stepped scan approach (90° at a time), or with multiple 90° used (faces simultaneously in 4 different directions). The use of ADS-B provides plane data may be also allow for providing flight plan. The drone may utilize Autonomous engine and may incorporate processors implementing optimized algorithms for processing and using sensor data (e.g., to determine course of action).

In some implementations, network arrangements incorporating network edge extending functions may be configured to provide artificial intelligence (AI) based sensing and autonomous response. This may be particularly possible and/or optimized in conjunction with the extending of network edges and/or accessibility to cloud resources. Such AI based solutions may include and/or entails use of one or more of AI based sensing, AI based autonomy, and AI based cloud services. With respect to AI based sensing, data acquisition may be performed using radar/radios incorporating AI based sensors and/or processing resources that support use of AI based processing. In this regard, formed RF meshes may enable new levels of data sharing for distributed sensing. Such radars may be optimized for drones or handheld devices. AI software may fuse optical and radar data, such as using AI deep learning techniques. The software may integrate data from 3rd party optical, LIDAR, thermal/IR and other sources as needed. Sensors may be handheld, ground based, and/or deployed on drones. Multiple object classification & tracking, even in foggy or smoky conditions.

Artificial intelligence (AI) based autonomy may be utilized when acting on acquired data. Sensors, people, vehicles and drones may coordinate data in real-time through RF mesh network. Autonomy software may be used to enable and ensure autonomous drone response and provide AI based assistance to operators. This may allow for multiple object classification and tracking, even in low visibility (e.g., foggy or smoky) conditions. Automated drones may extend sensing over distance and rapidly inspect areas of interest. This may allow for intelligent detect and avoid, or detect and track navigation.

With respect to AI cloud services, users may use AI cloud services or solutions (e.g., cloud-based software applications) to run their data. For example, users' sensor data may be rendered into detailed 3D models (e.g., terrain, structures, areas of interest, etc.). The use of such service may also allow for detecting safety hazards (e.g., in structures, terrain, certain locations, etc.), and/or detecting safety/security issues. In some instances, open architecture may be used/supported to enable running or incorporate applications from different sources (e.g., combining provider's proprietary neural networks with user's and/or 3rd party's AI applications).

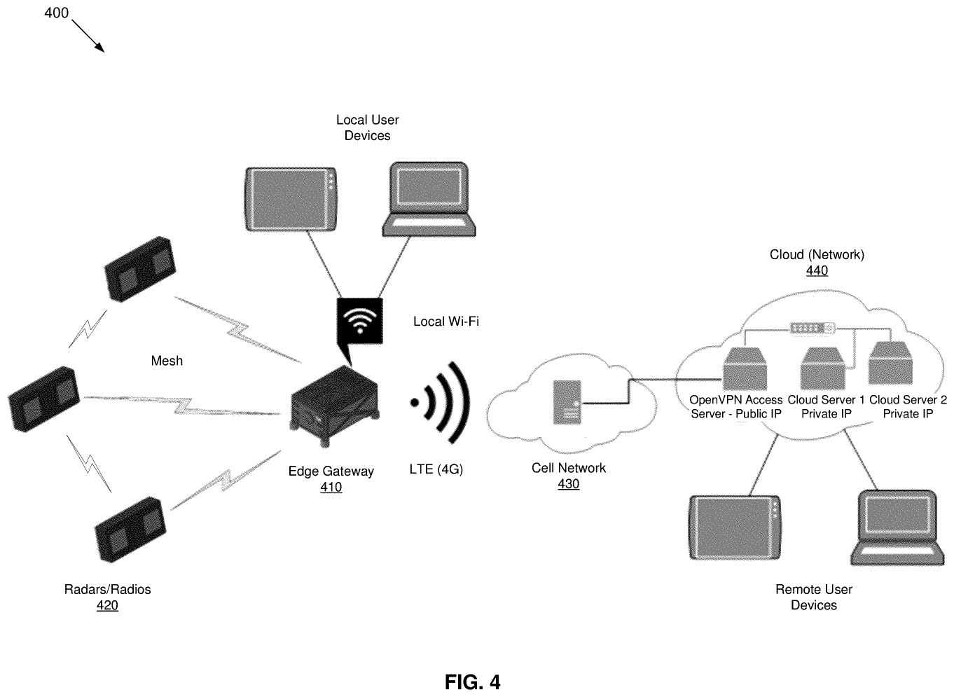

FIG. 4 shows an example use case of an edge gateway, in accordance with an example embodiment of the disclosure. Shown in FIG. 4 is a network arrangement 400 that is configured for supporting extending the network edge as described herein.

The network arrangement 400 comprises, for example, an edge gateway 410 (similar to the edge gateway(s) 310 as described with respect to FIG. 3), one or more radar/radio elements 420 (similar to the more radar and communication element(s) 330 as described with respect to FIG. 3), a cell network 430, a cloud (network) 440, local user devices, remote user devices.

The cell network 430 may be any suitable cellular network. For example, the cell network 430 may provide 4G/LTE coverage, with other devices/networks utilizing 4G/LTE radios for facilitating interactions with/via the cell network 430. Nonetheless, while the implementation illustrated in FIG. 4 includes and uses a cell network, the disclosure is not so limited, and any suitable wired and/or wireless network or connection(s) providing Cloud interface may be used.

The cloud (network) 440 may be comprise one or more servers (and other systems) for providing cloud related services. For example, as shown in FIG. 4, the cloud (network) 440 comprises OpenVPN Access Server and two cloud servers (server 1 and server 2), and one or more switches configured for facilitating interactions among the various elements of the cloud (network) 440.

Illustrated in FIG. 4 is an example use of edge gateway, such as the edge gateway 410, for supporting drone operations. In such scenarios, there may be multiple drones (e.g., AI enabled drones) that communicate over a mesh. The edge gateway 410 is a member of the mesh and bridges the mesh network to a local Wi-Fi access point that enables local user devices to utilize the drones—e.g., view live mission data, such as high-resolution streaming video, or radar tracking data. Since the mesh may not require any external communication infrastructure to operate, the local user device may be able to establish persistent, assured and secure communications to other mesh nodes, thus achieving, e.g., over 400 Mbps of throughput with very low latency.

The edge gateway 410 also connects securely to the cloud (network) 440, e.g., using 4G/LTE connection (via the cell network 430), such as by establishing a secure VPN tunnel. All local data at the edge gateway 410 may be aggregated, processed, and mirrored to the cloud (network) 440 for secure storage therein and also for secure remote internet-enabled access via the cloud (network) 440, such as by the remote user devices. Thus, the remote user devices may be used to securely view data streamed to the cloud that is near-real time or they are able to control drones at the point of operations for beyond visual line of sight (BVLOS) flight.

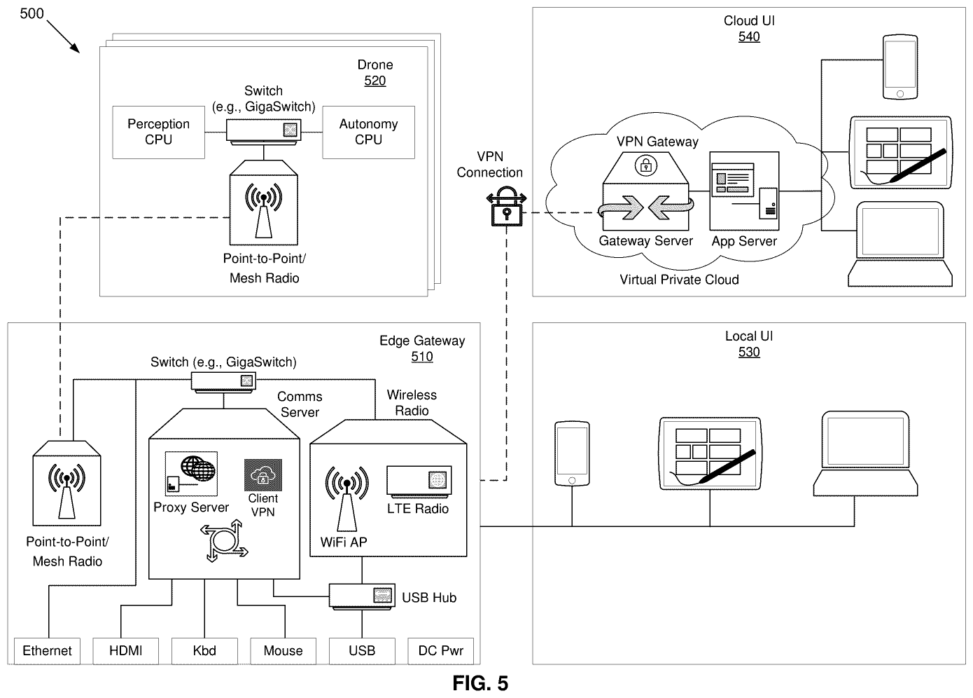

FIG. 5 shows an example network architecture with edge gateway in communication with network nodes, local resources and remote resources, in accordance with an example embodiment of the disclosure. Shown in FIG. 5 is network architecture 500 that is configured for supporting extending the network edge as described herein.

The network architecture 500 comprises an edge gateway 510, one or more artificial intelligence (AI) drones 520, local user interface (UI) 530, and cloud user interface (UI) 540. The edge gateway 510 may comprise a point-to-point or mesh (P2P/mesh) radio for communicating within a mesh (e.g., with the drones 520), a communication server, a wireless radio, a Universal Serial Bus (USB) hub, and a switch (e.g., a GigaSwitch) for facilitating interactions among the various elements of the edge gateway 510. The P2P/mesh radio may be configured for enabling communicating with the drones 520 (via corresponding P2P/mesh radio(s) therein). The communication server may be configured for facilitating and controlling communication functions—e.g., controlling and utilizing local interfaces (e.g., Ethernet, High-Definition Multimedia Interface (HDMI), USB, keyboard, mouse, DC power, and the like (and peripheral devices connected thereto, if any). The communication server may also be configured to provide VPN client function to facilitate interactions with cloud server(s). The wireless radio may comprise cell radio configured to provide cellular connectivity (e.g., 4G/LTE, 5G, etc.) with/via cellular network(s), and a Wi-Fi access point for providing localized Wi-Fi communication.

Each of the drones 520 may comprise a perception processor/circuit (or CPU), an autonomy processor/circuit (or CPU), a P2P/mesh radio for communicating within a mesh (e.g., with the edge gateway 510 and/or with other drones 520), and a switch (e.g., a GigaSwitch) for facilitating interactions among the various elements of the drone 520. The P2P/mesh radio may be configured for enabling communicating with the edge gateway 510 (via corresponding P2P/mesh radio(s) therein). The perception processor/circuit (or CPU) and the fusion processor/circuit may be configured to facilitate and support, inter alia, AI sensing, fusing, and sharing functions, as described above for example. Nonetheless, the disclosure is not so limited, and as such in some implementations, a single processor may be configured to perform both types of processing, whereas in other implementation one or both of the processors may be eliminated and functions or operations associated therewith may be offloaded from the drone into other nodes or elements in the network, such as the sensors, the edge gateway, the cloud, etc. In some implementations, at least one of the drones 520 may be an artificial intelligence (AI) based drone.

The local user interface (UI) 530 may comprise one or more local user/UI devices (e.g., mobile phones, tablets, personal computers, etc.). The cloud user interface (UI) 540 may comprise a virtual private cloud and one or more remote user/UI devices. The virtual private cloud may comprise one or more servers (and other systems) for providing VPN based cloud related services. For example, as shown in FIG. 5, the virtual private cloud may comprise VPN gateway server and an application (app) server.

The edge gateway 510 may bridge the drones 520 (and any mesh formed thereby) to local and/or remote user devices. Data available at the edge gateway 510 may be aggregated, processed, and made available to the local user interface (UI) 530 and/or cloud user interface (UI) 540. In this regard, the Wi-Fi access point in the edge gateway 510 may enable local user devices to utilize the drones—e.g., view live mission data, such as high-resolution streaming video, or radar tracking data. Further, the edge gateway 510 may provide secure connectivity to remote device, such as VPN connection(s). In this regard, the communication server may be used in establishing a secure VPN tunnel to the VPN gateway of the cloud user interface (UI) 540, such as using cellular (e.g., 4G/LTE) links via the LTE radio. The virtual private cloud may then provide secure remote access by the remote user/UI devices. The same arrangement(s) may allow for control of the drone 520 by the local user/UI devices (e.g., via the local Wi-Fi access point, then through the switch and the P2P/mesh radio(s)) and/or the remote user/UI devices (e.g., via the VPN connection over the 4G/LTE link(s), then through the switch and the P2P/mesh radio(s)).

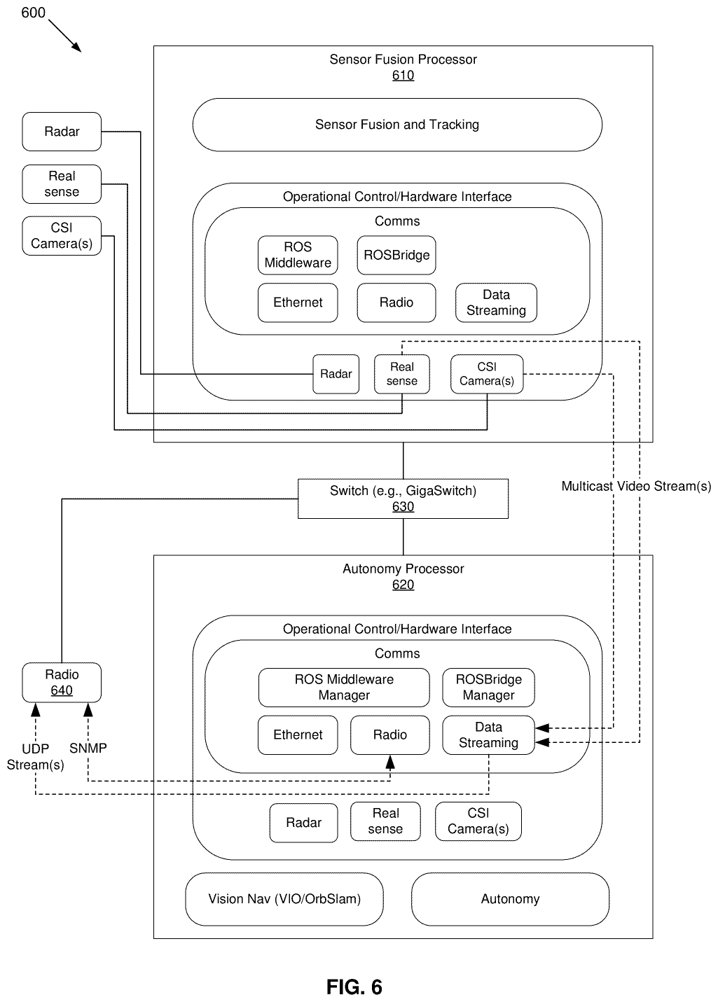

FIG. 6 shows an example implementation of a drone that may be utilized in accordance with an example embodiment of the disclosure. Shown in FIG. 6 is artificial intelligence (AI) drone 600 (or a portion thereof). In this regard, the drone 600 may be configured for supporting extending the network edge as described herein. The drone 600 may correspond to the one of the drones 520 of FIG. 5, and as such in some instances, the drone 600 may be an artificial intelligence (AI) based drone. The drone 600 comprises a sensor fusion processor, an autonomy processor, a switch 630, and a radio 640 (e.g., P2P/mesh radio). Nonetheless, as noted above, the disclosure is not limited to the embodiment(s) illustrated in FIGS. 5 and 6, and as such in some implementations, a single processor may be configured to perform both types of processing, whereas in other implementation one or both of the processors may be eliminated and functions or operations associated therewith may be offloaded from the drone into other nodes or elements in the network, such as the sensors, the edge gateway, the cloud, etc. For example, the sensor fusion processor (and thus corresponding fusion processing) may be incorporated into the sensors.

Illustrated in the example implementation shown in FIG. 6 are various example subcomponents of some of the components of the drone 600 (e.g., the sensor fusion processor or circuit 610 and the autonomy processor or circuit 620) and example interactions between the components of the drone 600, specifically to facilitate and support the AI based sensing, fusing, processing, controlling, etc. in the drone 600, particularly in the course of network edge extending related operations. For example, the drone 600 may incorporate, be coupled to, and/or may be in communication with radar(s), real sensors (e.g., infrared based sensors), camera(s), and the like. Data obtained via these sensory devices or elements may be processed in the sensor fusion processor. This may comprise use of AI based fusion—e.g., using neural networks, each being configured for particular type of sensory data (e.g., radar, infrared, optical, etc.), and/or for fusing such sensory data to generate an overall sensory data. The sensory data, whether obtained/generated within the drone or obtained from other nodes or elements, may be used in operation of the drone, particularly with respect to autonomous operation of the drone.

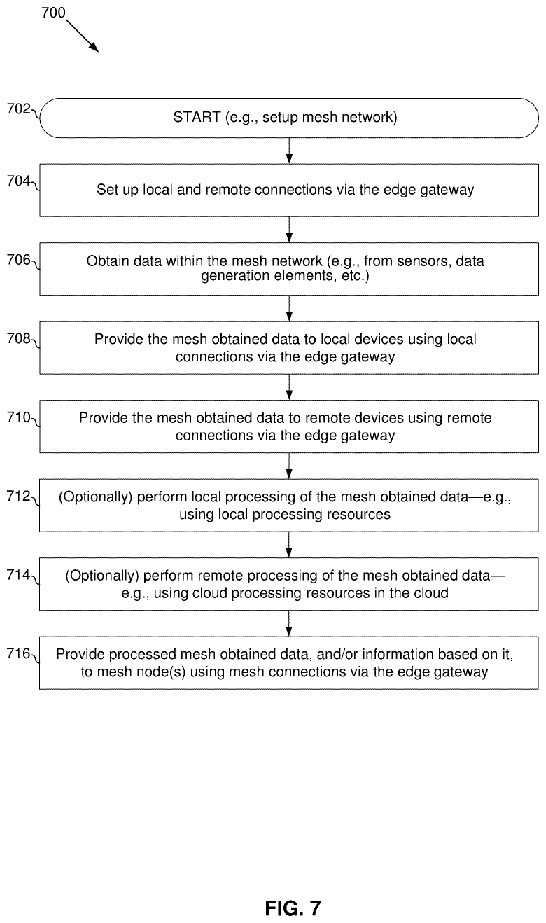

FIG. 7 shows a flowchart of an example method of utilizing edge gateways, in accordance with an example embodiment of the disclosure. Shown in FIG. 7 is flow chart 700, comprising a plurality of example steps represented as blocks 702-714.

In start step 702, a mesh network may be set up, and operations may initiate. The mesh network may comprise at least one edge gateway as described herein along with one or more other network nodes, which comprise aerial drones, sensors (mobile and/or fixed), data generation elimination, etc.

In step 704, local and remote connections may be set up via the edge gateway. This may comprise mesh based connection with other nodes in the mesh network, local connections (e.g., wireless, such as Wi-Fi based) with local user devices (e.g., mobile phones, tablets, laptops, etc.), and/or remote connections (e.g., via cellular networks or the like) to Cloud elements/resources.

In step 706, data may be obtained within the mesh network (e.g., via the drones, sensors, data generation elements, etc.). The obtained data may be fused in some instances, such as using fusion processing resources within the mesh network (e.g., in the drones, in the edge gateway, etc.). In some instances, AI sensing may be used while obtaining or generating data in the mesh network (referred to hereinafter as “mesh obtained data”), such as data from devices in the mesh network, and/or AI based fusion processing may be used when fusing obtained data (e.g., sensory data).

In step 708, the mesh obtained data may be provided to local devices using local connections via the edge gateway.

In step 710, the mesh obtained data may be provided to remote devices using remote connections via the edge gateway.

In step 712, the mesh obtained data may be processed locally—e.g., in the edge gateway or other local processing resources, which may be configured process such data.

In step 714, the mesh obtained data may be processed in remote resources—e.g., in the Cloud, using Cloud based processing resources.

In step 716, processed mesh obtained data and/or information generated based on processing of the mesh obtained data may be provided via the edge gateway to mesh node(s), such as using mesh connections.

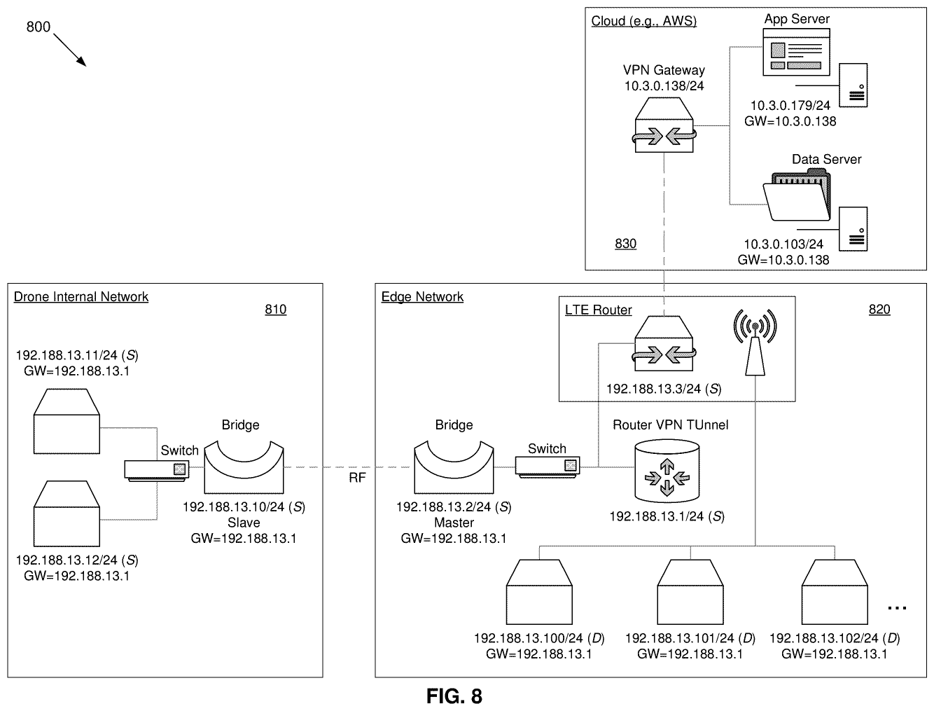

FIG. 8 shows an example network architecture that comprises a drone internal network, an edge network, and a cloud network, in accordance with an example embodiment of the disclosure. Shown in FIG. 8 is a network arrangement 800 that is configured for supporting extending the network edge as described herein. The network arrangement 800 comprises, for example, a drone internal network 810, an edge network 820, and a cloud (network) 830.

The drone internal network 810 may be a drone-based network configured for extending the network edge as described herein. As such, the drone internal network 810 may comprise, in addition to drones, one or more bridge(s), and one or more switches (for facilitating interactions among the various elements of the drone internal network 810). The one or more bridge(s) may be configured for providing connectivity to other systems or networks that support or facilitate extending the network edge related operations, such as the edge network 820.

The edge network 820 may be a network configured for supporting extending the network edge as described herein. For example, the edge network 820 may be configured for supporting and/or facilitating interactions between the drone internal network 810 and the cloud (network) 830. The edge network 820 may comprise, in addition to network nodes, one or more bridge(s), one or more routing elements, and one or more switches configured for facilitating among the various elements of the drone internal network 810. The one or more one or more bridge(s) may be configured for providing bridging connectivity with other systems or networks that support or facilitate extending the network edge related operations, such as with the drone internal network 810.

The one or more routing elements may be configured for providing routing functions, such as to facilitate communications between the drone internal network 810 (and elements thereof) and the cloud (network) 830. For example, the one or more routing elements may comprise a Router VPN Tunnel and a 4G/LTE router, which may be configured to provide to provide connectivity (e.g., using 4G/LTE radios for facilitating interactions with/via cellular network(s)) to the cloud (network) 830, and a Wi-Fi access point for providing local Wi-Fi communication.

The cloud (network) 830 may comprise one or more servers (and other systems) for providing cloud related services, and may be particularly configured for supporting extending the network edge as described herein. For example, as shown in FIG. 8, the cloud (network) 830 comprises a VPN gateway (server), an application (app) server, and a data server.

In example network edge extending related operation, the bridges in the drone internal network 810 and the edge network provide connectivity (e.g., RF based), with the switch(s) in the drone internal network 810 enabling communication to/from the drone-side bridge within the drone internal network 810, and the switch(s) in the edge network 820 enabling communication to/from the drone-side bridge within the edge network 820. Further, edge extending related communication are routed within the edge network 820 to/from the cloud (network) 830 via the routing elements of the edge network 820—e.g., the Router VPN Tunnel and an 4G/LTE router.

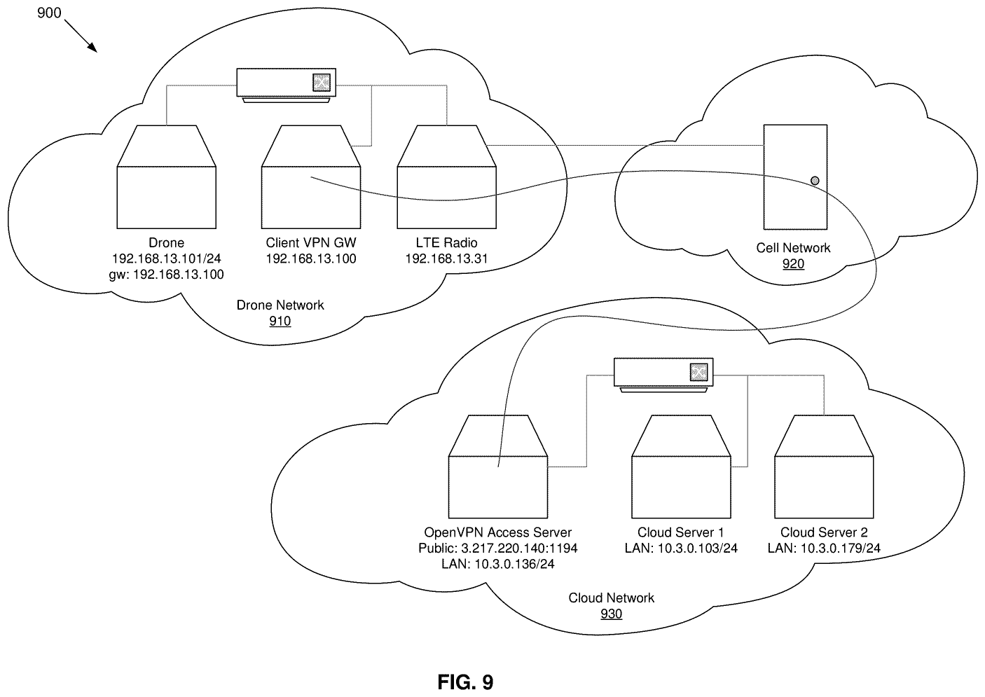

FIG. 9 shows an example use case in a network architecture that comprises a drone network, a cloud network, and a cellular network, in accordance with an example embodiment of the disclosure. Shown in FIG. 9 is a network arrangement 900 that is configured for supporting extending the network edge as described herein. The network arrangement 900 comprises, for example, a drone network 910, a cell network 920, and a cloud (network) 930.

The drone network 910 may be a drone based network configured for extending the network edge as described herein. As such, the drone network 910 may comprise, in addition to drones, one or more edge gateways, radios for providing connectivity via other networks (e.g., 4G/LTE radios for facilitating interactions with/via cellular network, such as the cell network 920), and one or more switches configured for facilitating interactions among the various elements of the drone network 910.

The cloud (network) 930 may comprise one or more servers (and other systems) for providing cloud related services, and may be particularly configured for supporting extending the network edge as described herein. For example, as shown in FIG. 9, the cloud (network) 930 comprises OpenVPN Access Server and two cloud servers (server 1 and server 2), and one or more switches configured for facilitating interactions among the various elements of the cloud (network) 930.

As illustrated in the example use case depicted in FIG. 9, the network edge extending capabilities of the drone network 910 may enable interactions with the cloud (network) 930, via the cell network 920, such as using an edge gateway incorporated into the drone network 910 as a VPN client, which may be communicated with the OpenVPN Access Server of the cloud (network) 930 via an 4G/LTE radio (incorporated into the drone network 910) and the cell network 920, as shown.

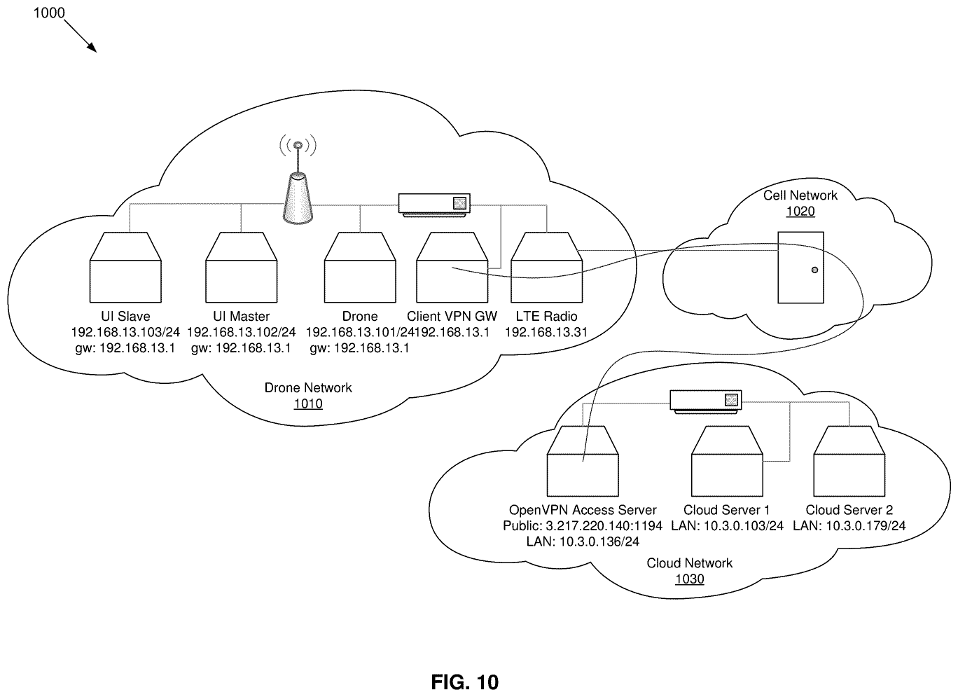

FIG. 10 shows another example use case in a network architecture that comprises a drone network, a cloud network, and a cellular network, in accordance with an example embodiment of the disclosure. Shown in FIG. 10 is a network arrangement 1000 that is configured for supporting extending the network edge as described herein. The network arrangement 1000 comprises, for example, a drone network 1010, a cell network 1020, and a cloud (network) 1030.

The drone network 1010 may be a drone based network configured for extending the network edge as described herein, and may be substantially similar to the drone network 910 of FIG. 9. As such, the drone network 1010 may comprise, in addition to drones, one or more edge gateways, one or more radios for providing connectivity via other networks (e.g., 4G/LTE radios for facilitating interactions with/via cellular network, such as the cell network 1020), and one or more switches configured for facilitating interactions among the various elements of the drone network 1010. However, the drone network 1010 may additionally comprise user interface (UI) elements, which may be configured and/or operated as slave or master devices.

The cloud (network) 1030 may be substantially similar to the cloud (network) 930 of FIG. 9, and as such similarly may comprise one or more servers (and other systems) for providing cloud related services, and may be particularly configured for supporting extending the network edge as described herein. For example, as shown in FIG. 10, the cloud (network) 1030 comprises OpenVPN Access Server and two cloud servers (server 1 and server 2), and one or more switches configured for facilitating interactions among the various elements of the cloud (network) 930.

As illustrated in the example use case depicted in FIG. 10, the network edge extending capabilities of the drone network 1010 may enable interactions with the cloud (network) 1030, via the cell network 1020, such as using an edge gateway incorporated into the drone network 1010 as a VPN client, which may be communicated with the OpenVPN Access Server of the cloud (network) 1030 via an 4G/LTE radio (incorporated into the drone network 1010) and the cell network 1020, as shown.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various spatial and directional terms, such as top, bottom, lower, mid, lateral, horizontal, vertical, front and the like may be used to describe embodiments, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the disclosed technology is not limited in its application to the details of construction and the arrangement of the components set forth in the description or illustrated in the drawings. The technology is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. An edge gateway node operating in conjunction with a mesh network comprising one or more mesh nodes, the edge gateway comprising:
a radio configured for communication within the mesh network;
one or more control circuits configured for one or both of controlling and processing of data; and
a communication module comprising one or more communication circuits configured to facilitate or support local communication with one or more local devices that are not part of the mesh network, and/or remote communication with one or more remote systems.

2. The edge gateway node of claim 1, wherein the communication module comprises a Wi-Fi access point component configured to handle wireless local network access.

3. The edge gateway node of claim 1, wherein the communication module comprises a cellular radio component configured to handle handling communication via cellular based connections.

4. The edge gateway node of claim 3, wherein the cellular radio component comprises 4G/LTE radio.

5. The edge gateway node of claim 1, wherein the communication module comprises or is coupled to a multiple-input and multiple-output (MIMO) antenna, and wherein the one or more communication circuits is configured to support or control communication via the MIMO antenna.

6. The edge gateway node of claim 1, wherein the one or more communication circuits are configured to set up and use local network based communication with the one or more local devices, using one or more local wired and/or wireless connections via the communication module.

7. The edge gateway node of claim 1, wherein the one or more communication circuits are configured to enable cloud based communication, with a cloud network, using one or more connections via the communication module.

8. The edge gateway node of claim 7, wherein the one or more communication circuits are configured to set up and use virtual private network (VPN) based communication with the cloud network.

9. The edge gateway node of claim 7, wherein the one or more communication circuits are configured to communicate mesh-related data with at least one remote system via the cloud based routing.

10. The edge gateway node of claim 7, wherein the one or more communication circuits are configured to adaptively process data for communication to the one more remote systems and the one or more local devices.

11. The edge gateway node of claim 10, wherein the one or more control circuits are configured to adjust or throttle in real-time data based on communication related parameters, wherein the communication related parameters comprise one or both of bandwidth and latency.

12. The edge gateway node of claim 1, wherein the one or more control circuits are configured to process data obtained within the mesh network.

13. The edge gateway node of claim 12, wherein the one or more control circuits are configured to fuse at least some of the data obtained within the mesh network.

14. The edge gateway node of claim 12, wherein the one or more control circuits are configured to process at least some of the data using artificial intelligence (AI) based processing.

15. The edge gateway node of claim 1, wherein the one or more mesh nodes comprise at least one sensor.

16. The edge gateway node of claim 1, wherein the one or more mesh nodes comprise at least one data generation element.

17. A method of operating a local mesh network, the method comprising:
establishing the local mesh network, wherein the local mesh network comprises an edge gateway and one or more mesh nodes;
providing via the edge gateway, to one or more local devices, local access to mesh obtained data, wherein the mesh obtained data comprises data obtained or generated within the mesh network; and
providing via the edge gateway, to one or more remote systems, remote access to the data from the mesh, wherein the remote access enables use of cloud based resources for processing of the mesh obtained data in the cloud.

18. The method of claim 17, wherein the local mesh network further comprises one or more sensors, wherein the mesh obtained data comprises sensory data, and further comprising obtaining at least some of the sensory data via the one or more sensors.

19. The method of claim 18, further comprising fusing at least portion of the sensory data.

20. The method of claim 19, further comprising fusing the at least portion of the sensory data in one or more of: the one or more sensors, one or more mesh nodes, the edge gateway, and one or more remote or local processing resources.

21-23. (canceled)
